(19) United States
(12) Patent Application Publication
(10) Pub. No.: US 2002/0024757 A1
(43) Pub. Date: Feb. 28, 2002

(54) Disk drive capable of easily switching between rotational driving units of different mechanisms

(75) Inventor: Munehisa Haitani, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 09/932,231

(22) Filed: Aug. 17, 2001

(30) Foreign Application Priority Data
Aug. 28, 2000 (JP) 2000-257323

(51) Int. Cl. G11B 19/02

(52) U.S. Cl. 360/69; 360/71

(57) ABSTRACT

A disk drive includes a spindle motor (SPM) with a sensor. When the SPM with the sensor is set, an SPM driver outputs a low signal (L) to control unit. When a sensorless SPM is set, another SPM driver outputs a high signal (H) to the control unit. In response to the low signal, the control unit is switched to control the rotation of the SPM with the sensor. In response to the high signal, the control unit is switched to control the rotation of the sensorless SPM.

### BACKGROUND OF THE INVENTION

1. Field of the Invention

The present invention relates to disk drives used as, for example, floppy disk drives. More particularly, the present invention relates to a disk drive which can easily change and set rotational driving units of different mechanisms.

2. Description of the Related Art

In disk drives such as floppy disk drives, a rotational driving unit for spinning a disk is provided. The rotational driving unit includes a spindle motor (SPM) provided with a turntable and an SPM driver. The SPM driver is connected to a control IC (control unit).

For example, a three-phase brushless motor can be used as the SPM. In general, a Hall element has been conventionally used as a rotation sensor for detecting the number of rotations of the SPM. Recently, instead of using the Hall element, an SPM capable of detecting the number of rotations has been used.

FIGS. 2A and 2B and FIGS. 3A and 3B are block diagrams of examples of a conventional disk drive which includes a combination of a control IC and an SPM driver.

Referring to FIG. 2A, an SPM 32A with a sensor, i.e., a Hall element, and an SPM driver 31A are connected to a control IC 30A. Referring to FIG. 2B, a sensorless SPM 32B (without a Hall element) and an SPM driver 31B are connected to a control IC 30B which differs from the control IC 30A.

Referring to FIGS. 3A and 3B, a combination of the SPM 32A and the SPM driver 31A and another combination of the SPM 32B and the SPM driver 31B are connected to the same control IC 40. The control IC 40 is provided with a switch 50.

In the conventional disk drives shown in FIGS. 2A and 2B and FIGS. 3A and 3B, the following problems occur.

Specifically, if the disk drives shown in FIGS. 2A and 2B are employed, the following problem occurs when the parts are assembled. When connecting the SPM 32A with the sensor and the sensorless SPM 32B to a control IC, it is necessary to separately provide the control IC 30A that corresponds to the SPM 32A with the sensor and the control IC 30B that corresponds to the sensorless SPM 32B. If the disk drives shown in FIGS. 3A and 3B are employed, the SPM 32A with the sensor and the sensorless SPM 32B can share the same control IC 40. However, it is necessary to provide the switch 50 for switching between the SPM 32A with the sensor and the sensorless SPM 32B.

The manufacturing process of each disk drive formed of a combination of a control IC and a SPM driver, as shown in FIGS. 2A and 2B and FIGS. 3A and 3B, is complicated. The number of parts is increased, and hence the cost is also increased.

### SUMMARY OF THE INVENTION

In order to solve the foregoing problems, it is an object of the present invention to provide a disk drive which can handle different types of SPMs by switching from one type to another without increasing the number of parts and making the manufacturing process complicated.

According to the present invention, a disk drive is provided including a rotational driving unit for spinning a disk. A head reads and/or writes a signal to the disk. A head transfer unit moves the head along a disk surface. A control unit controls the rotational driving unit. The rotational driving unit outputs an identification signal that differs in accordance with the difference between rotation detecting methods of detecting the number of rotations. The control unit switches control processing with respect to the rotational driving unit based on the identification signal.

The rotational driving unit may include a first rotational driving unit and a second rotational driving unit. The first rotational driving unit may include a spindle motor with a sensor that detects the number of rotations and a first motor driver that controls the motor. The second rotational driving unit may include a sensorless spindle motor that detects the number of rotations without using a sensor and a second motor driver that controls the motor. Different identification signals may be output from the first rotational driving unit and the second rotational driving unit.

Preferably, the second rotational driving unit controls the number of rotations of the motor based on back electromotive force induced in a driving coil of the motor.

According to the present invention, even when different types of rotational driving units are connected to the disk drive, processing is automatically switched in accordance with the type of rotational driving unit. Thus, it is unnecessary to provide a control unit in accordance with the type of rotational driving unit. When a control unit is shared, it is unnecessary to provide a switch. Thus, the manufacturing process is simplified, the number of parts is reduced, and hence the cost can be reduced.

Preferably, when the first rotational driving unit is connected to the control unit and when the power is turned on, a low signal is output as the identification signal, and, when the second rotational driving unit is connected to the control unit and when the power is turned on, a high signal is output as the identification signal.

Alternatively, when the first rotational driving unit is connected to the control unit and when the power is turned on, a high signal can be output as the identification signal, and, when the second rotational driving unit is connected to the control unit and when the power is turned on, a low signal can be output as the identification signal.

### BRIEF DESCRIPTION OF THE DRAWINGS

FIG. 1 is a block diagram of a disk drive according to an embodiment of the present invention;

FIG. 2A is a block diagram of the partial structure of a conventional disk drive using an SPM with a sensor, and FIG. 2B is a block diagram of the partial structure of a conventional disk drive using a sensorless SPM; and

FIG. 3A is a block diagram of the partial structure of another conventional disk drive using an SPM with a sensor, and FIG. 3B is a block diagram of the partial structure of another conventional disk drive using a sensorless SPM.

### DESCRIPTION OF THE PREFERRED EMBODIMENTS

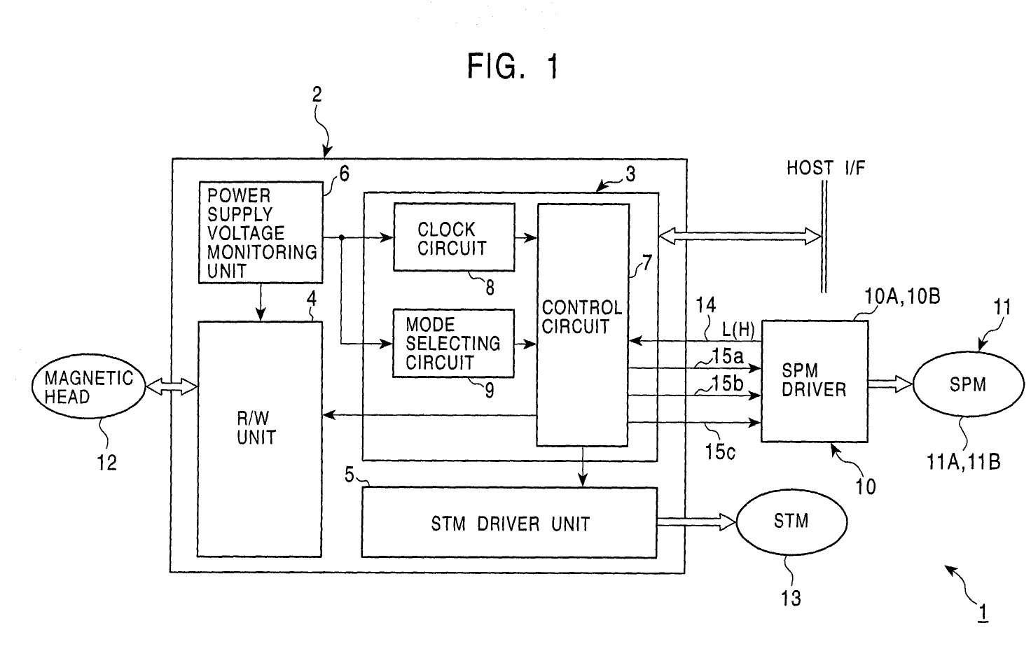

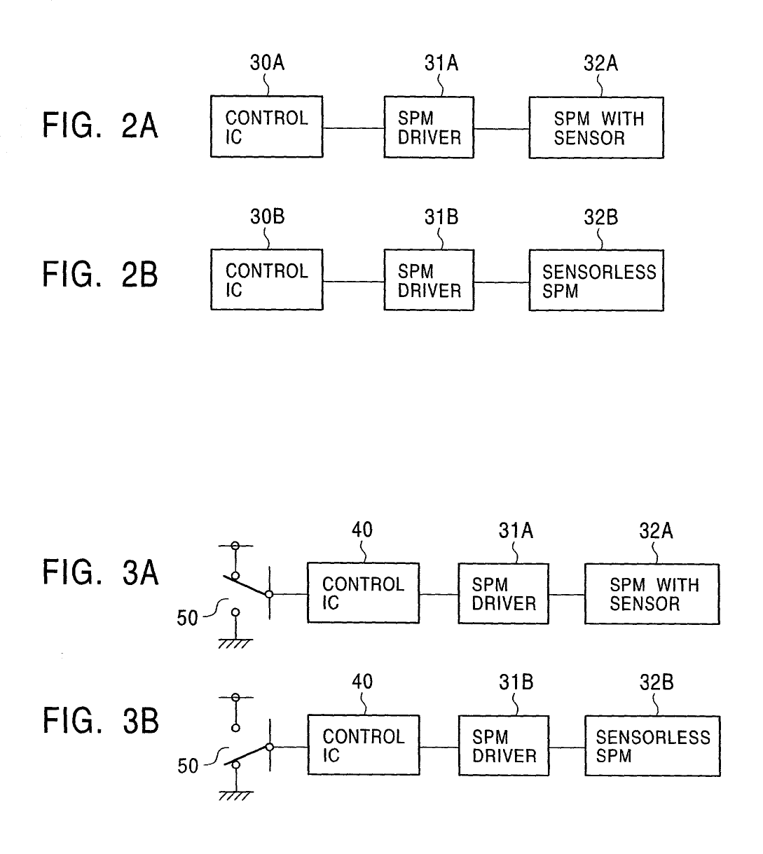

FIG. 1 shows the structure of a disk drive according to an embodiment of the present invention.

Referring to FIG. 1, a disk drive 1 is used as a floppy disk drive. It is possible to set two types of SPMSs having different internal mechanisms, i.e., different rotation detectors. For example, a three-phase brushless motor is used as the SPM.

The disk drive 1 includes a control unit 2, an SPM 11 which is a rotational driving unit, an SPM driver 10, a stepping motor (STM) 13 which is a head transfer unit, and a magnetic head 12. The SPM 11, the magnetic head 12, and the STM 13 are controlled by the control unit 2 formed of a control IC.

The SPM 11 is provided with rotation detectors for detecting the number of rotations of the motor. There are two types of motors having different rotation detectors. One type uses a Hall element, that is, a sensor, to perform a detection. The other type is a sensorless type which does not use a Hall element to perform a detection. The former type is referred to as an SPM 11A with a sensor, and the latter type is referred to as a sensorless SPM 11B which is a motor without a sensor. Both the SPM 11A with the sensor and the sensorless SPM 11B can be set in the disk drive 1.

The sensor used for the SPM 11A includes a rotor which is rotatably supported by a stator which functions as a fixed part. The stator includes three-phase driving coils (U, V, and W) and three Hall elements disposed adjacent to the corresponding driving coils. The interior of a rotor case (not shown) is provided with a ring-shaped rotor magnet in which the N-pole and the S-pole are alternately disposed. Each Hall element is provided at a position opposed to the rotor magnet. When the rotor magnet rotates, each magnetic pole of the rotor magnet passes in front of each Hall element, and hence each Hall element detects a change in the magnetic field.

The sensorless SPM 11B uses a stator with a terminal at the middle thereof. When the motor is rotated, and when a magnetic flux of the rotor magnet crosses a driving coil, back electromotive force which is induced between the terminal and the driving circuit is detected.

The SPM 11A with the sensor includes an SPM driver 10A (a first motor driver). The SPM 11A and the SPM driver 10A form a first rotational driving unit. The sensorless SPM 11B includes an SPM driver 11B (a second motor driver) which differs from the SPM driver 11A. The SPM 11B and the SPM driver 11B form a second rotational driving unit. The SPM drivers 10A and 11B are connected to and controlled by the control unit 2.

The control unit 2 includes a logic-arithmetic unit 3, a read/write (R/W) unit 4, an STM driver unit 5, and a power supply voltage monitoring unit 6. The logic-arithmetic unit 3 is connected to the SPM 11. The read/write unit 4 is connected to the magnetic head 12. The STM driver unit 5 is connected to the STM 13.

The logic-arithmetic circuit 3 is connected through a predetermined interface to a floppy disk controller (not shown) provided at a host computer side. The floppy disk controller controls the timing of the reading and writing of data (signals), a seek request signal, and the like.

The logic-arithmetic unit 3 includes a control circuit 7, a clock circuit 8, a mode selecting circuit 9, and the like. The control circuit 7 controls the overall disk drive 1. Signals from the host computer are appropriately processed, and the processed signals are sent to the read/write unit 4, the STM driver unit 5, and the SPM driver 10. Signals from the read/write unit 4, the STM driver unit 5, and the SPM driver 10 are appropriately processed, and the processed signals are sent to the host computer.

The read/write unit 4 is formed of a read/write amplifier or the like. A recording signal from the host computer is formatted in the control unit 2. The formatted recording signal is sent to the magnetic head 12, and the magnetic head 12 in turn records the recording signal. A signal read by the magnetic head 12 from a disk is sent to the control unit 2 through the read/write unit 4, and the signal is decoded and transferred to the host computer.

The host computer includes a device driver for controlling the disk drive 1. The device driver performs processing in accordance with an operating system provided in the host computer.

The STM driver unit 5 controls driving of the STM 13 so that the magnetic head 12 moves in the radial direction of a disk. In this case, a seek command pulse which consists of a step pulse (one pulse for each track) and a seek request direction is output. Based on the seek command pulse, the disk drive 1 controls the magnetic head 12 so that the magnetic head 12 moves over a number of tracks in accordance with the number of seek command pulses.

The power supply voltage monitoring unit 6 monitors a voltage applied to the logic-arithmetic unit 3 and the read/write unit 4 and prevents an excess current from flowing into the circuits. The clock circuit 8 outputs a pulse signal at a predetermined frequency. In accordance with the pulse signal, the timing for driving the SPM 11 and the STM 13 is controlled. The mode selecting circuit 9 switches between a test mode for performing testing after manufacturing and a normal mode for ordinary use. The mode is switched in response to a predetermined switching signal supplied to the mode selecting circuit 9.

In the disk drive 1, the control unit 2 sends a motor on/off signal 15a, a switching signal 15b for detecting the number of rotations, and a clock signal 15c to the SPM driver 10. The SPM driver 10 sends an identification signal 14 (reference signal in synchronization with sector 0 of a disk) which is output every time a disk rotates to the control unit 2.

When the first rotational driving unit is connected to the disk drive 1, and when the power is turned on, the identification signal 14 which includes a low signal (L) is output to the control unit 2. In response to the low signal, the control unit 2 (logic-arithmetic unit 3) rotates and drives the SPM 11A with the sensor.

When the second rotational driving unit is connected to the disk drive 1, and when the power is turned on, the identification signal 14 which includes a high signal (H) is output to the control unit 2. In response to the high signal, the control unit 2 (logic-arithmetic unit 3) rotates and drives the sensorless SPM 11B.

The low signal and the high signal can be set as initial values which are output every time the SPM 11 rotates. Alternatively, the low signal and the high signal can be set so that they are output only once immediately after the power is turned on.

As described above, the control unit 2 formed of the control IC switches between the first rotational driving unit and the second rotational driving unit based on the low signal and the high signal included in the identification signals 14 obtained from the SPM 11A with the sensor and the sensorless SPM 11B. Alternatively, the low signal (L) can be used to control the second rotational driving unit, and the high signal (H) can be used to control the first rotational driving unit.

Accordingly, the low signal and the high signal are output from the SPM driver 10, and hence the control unit 2 switches processing based on the low signal and the high signal.

What is claimed is:

1. A disk drive comprising:
rotational driving means for spinning a disk;
a head for reading and/or writing a signal to the disk;
head transfer means for moving the head along a disk surface; and
a control unit for controlling said rotational driving means;
wherein said rotational driving means outputs an identification signal that differs in accordance with the difference between rotation detecting methods of detecting the number of rotations; and
said control unit switches control processing with respect to said rotational driving means based on the identification signal.

2. A disk drive according to claim 1, wherein:
said rotational driving means comprises first rotational driving means and second rotational driving means;
said first rotational driving means comprises a spindle motor with a sensor that detects the number of rotations and a first motor driver that controls the motor;
said second rotational driving means comprises a sensorless spindle motor that detects the number of rotations without using a sensor and a second motor driver that controls the motor; and
different identification signals are output from said first rotational driving means and said second rotational driving means.

3. A disk drive according to claim 2, wherein said second rotational driving means controls the number of rotations of the motor based on back electromotive force induced in a driving coil of the motor.

4. A disk drive according to one of claims 2 and 3, wherein:
when said first rotational driving means is connected to said control unit and when the power is turned on, a low signal is output as the identification signal; and
when said second rotational driving means is connected to said control unit and when the power is turned on, a high signal is output as the identification signal.
